(19) United States
(12) Patent Application Publication
(10) Pub. No.: US 2004/0139859 A1
(43) Pub. Date: Jul. 22, 2004

(54) Fan blade cut off system

(76) Inventor: Tai-Ching Lee, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/755,291

(22) Filed: Jan. 13, 2004

Related U.S. Application Data
(63) Continuation-in-part of application No. 10/223,303, filed on Aug. 20, 2002.

(51) Int. Cl. B01D 53/02

(52) U.S. Cl. 96/134

(57) ABSTRACT

A fan blade cut off system includes a mesh seat and a mesh cover. The mesh seat has a conductor. The mesh cover comprises a conductive plate corresponding to the conductor of the mesh seat. When the mesh cover is buckled to the mesh seat, the conductive plate engages with the conductor to form a closed circuit, and when the mesh cover is disengaged from the mesh seat, the circuit is in open status.

### FIELD OF THE INVENTION

This application is a continuation in part of my application filed on Aug. 20, 2002, Ser. NO. 10/223,303.

The present invention relates to a fan blade cut off system. This fan structure deals with a filtration layer being employed on the blade to protect the fan by cutting off the power when the mesh cover is disengaged.

### BACKGROUND OF THE INVENTION

U.S. Pat. Nos. 4,477,262; 4,781,525; 6,045,329; 6,254,726 and 6,368,393 disclose the teaching of having incorporated a filtration layer to the external surface of a fan blade. Wherein, the filtration layer is provided at where outside the space available for the rotation of the blade by forcing air to be either sucked or blown through the filtration layer for air filtration.

However, the filtration layer will clog after a period of time and requires to be replaced. This requires disengaging of the mesh. If a user does not remember to unplug the electric cord and touch the switch to activate the fan accidentally, which may cause injury to the user.

### SUMMARY OF THE INVENTION

It is the primary object of the present invention to provide a fan blade cut off system, which is safe to a user.

It is another object of the present invention to provide a fan blade cut off system, which corresponds to environmental requirement.

It is a further object of the present invention to provide a fan blade cut off system, which is easy to operate.

### BRIEF DESCRIPTON OF THE DRAWINGS

FIG. 1 is an exploded view of the present invention;

FIG. 2 is a side view of the present invention; and

FIG. 3 is an enlarged view taken along the circle 3 of FIG. 2.

### DETAILED DESCRIPTION OF THE PREFERRED EMBODIMENTS

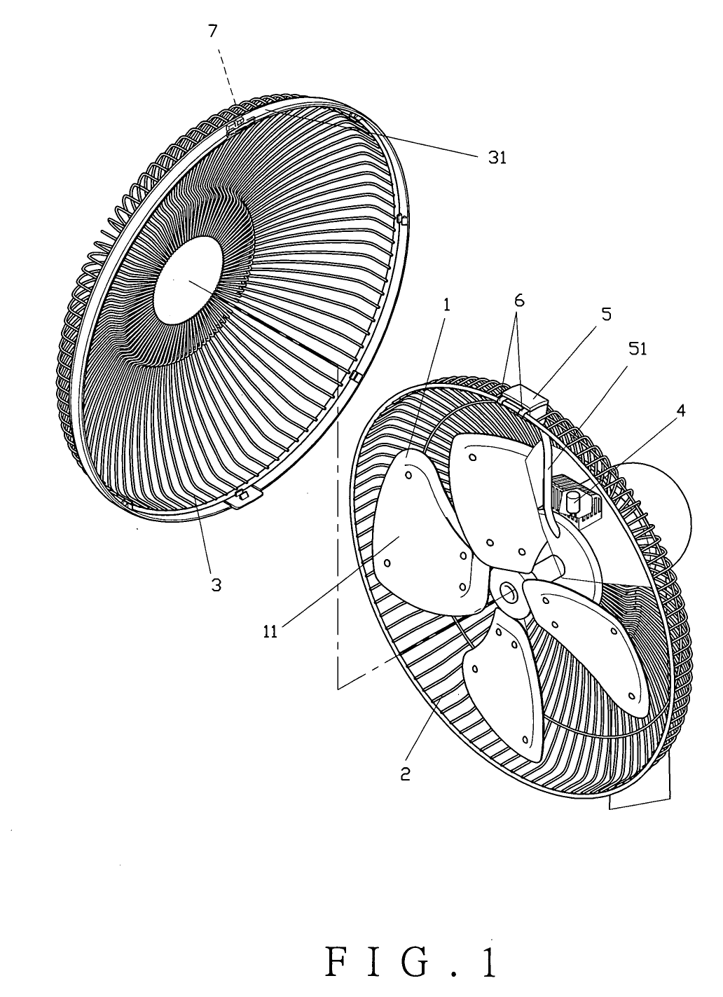

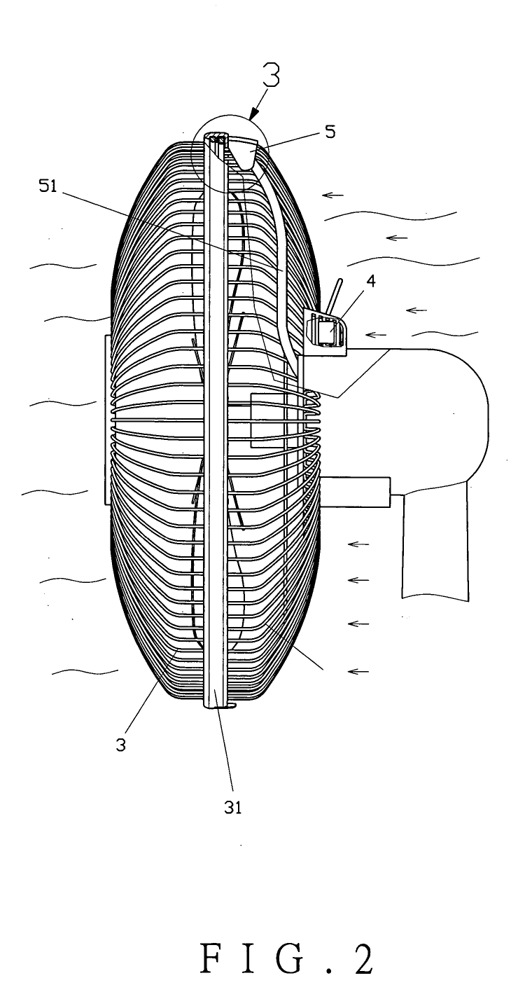

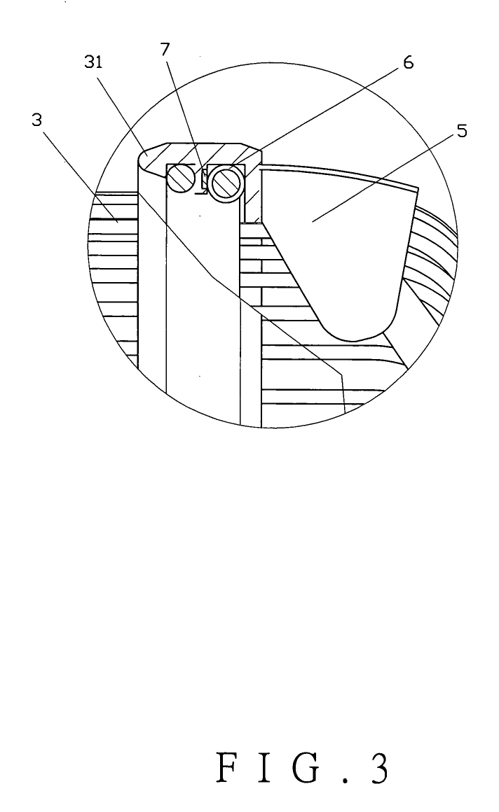

Referring to FIG. 1, the present invention comprises blades (1), a mesh seat (2), a mesh cover (3), a smoke detector (4), an ion generator (5), a conductor (6), and a conductive plate (7). Each blade (1) is fixed with a filtration layer (11) containing active carbon, jointly driven by a motor (not illustrated, nor elaborated due to the motor is a prior art). The mesh seat (2) is provided behind the blades (1). The mesh cover (3) is buckled to the mesh seat (2) by means of a locking slat (31). The smoke detector (4), the ion generator (5) and the conductor (6) are all mounted on the mesh seat (2). A wire tube (51) is adapted to the ion generator (5) to connect the wires (prior art/not illustrated) from the smoke detector (4), the ion generator (5) and the conductor (6) to a control circuit board (prior art, not illustrated, nor elaborated) of the electric fan. The conductor (6) is in its normally off status. The conductive plate (7) is provided on the mesh cover (3) in relation to the conductor (6). As illustrated in FIGS. 2 and 3, the conductor (6) is conducted when the mesh cover (3) is buckled to the mesh seat (2), thereby, when the smoke detector (4) automatically detects excessive smoke in the air, it sends signals to the control circuit board to command the blades (1) to rotate. Meanwhile, the ion generator (5) is also activated for the filtration layer (11) to filter the air and to de-odorize and sterilize the air jointly by the active carbon in the filtration layer (11) and ions generated from the ion generator (5) to improve air quality.

I claim:

1. A fan blade cut off system comprising a mesh seat and a mesh cover connected said mesh net, wherein said mesh seat comprising a conductor, and said mesh cover comprising a conductive plate connecting with said conductor of said mesh seat to form a closed circuit, whereas when disengaging said mesh cover from said mesh seat, said conductive plate disengaging from said conductor of said mesh seat and the circuit being in an open status.
